(19) United States
(12) Patent Application Publication
(10) Pub. No.: US 2021/0024334 A1
(43) Pub. Date: Jan. 28, 2021

(54) CRANE FOR A WIND FARM INSTALLATION VESSEL

(71) Applicant: Liebherr Werk Nenzing GmbH, Nenzing (AT)

(72) Inventors: Helmut FISCHER, Bludesch (AT); Stefan KOERTGE, Bludenz (AT)

(21) Appl. No.: 16/934,521

(22) Filed: Jul. 21, 2020

(30) Foreign Application Priority Data
Jul. 23, 2019 (DE) 10 2019 119 901.8

(51) Int. Cl. B66C 23/18; F03D 13/10; E02B 17/02; B66C 23/52; B66C 23/84

(52) U.S. Cl. CPC B66C 23/185; F03D 13/10; E02B 17/021; E02B 2017/006; B66C 23/84; F05B 2230/6102; B66C 23/52

(57) ABSTRACT

The invention relates to a crane as a component of a wind farm installation vessel which consists of a vessel body and a plurality of jack-up legs arranged in vertically movable manner thereon, wherein the crane is arranged rotatably about one of the jack-up legs. According to the invention, the crane is rotatably mounted on an eccentric platform which itself is arranged rotatably about the jack-up leg.

### CROSS-REFERENCE TO RELATED APPLICATION

The present application claims priority to German Patent Application No. 10 2019 119 901.8 filed on Jul. 23, 2019. The entire contents of the above-listed application is hereby incorporated by reference for all purposes.

The invention relates to a crane as a component of a wind farm installation vessel, according to the preamble of Claim 1.

What are called wind farm installation vessels or, according to English usage, jack-up vessels, which are also referred to as installation ships, have been developed in particular for constructing offshore wind power plants. In contrast to the jack-up rigs which are usual in the oil industry sector or for other offshore uses, wind farm installation vessels are special construction vessels constructed for foundation work and construction of offshore wind farms, and have at least one heavy-lift crane and their own engines and propulsion systems suitable for propulsion and dynamic positioning.

In addition to very large deck surfaces for receiving components, and a conventional vessel body and also further superstructures for crew accommodation, these wind farm installation vessels as a rule have powerful deck cranes with a high lifting capability from 2500 up to 10,000 t, which are frequently used for erecting wind power plants. The wind farm installation vessels are a particular vessel type, which can no longer be termed a jack-up rig, but represents a heavy transport vessel.

The wind farm installation vessels travel to their deployment site with their own engine at typical vessel speeds of up to 15 knots. There, they are erected at a fixed position in the sea with the aid of 4 to 6 hydraulically or electrically operated jack-up legs. During the journey to the deployment site, the jack-up legs are raised. Only once the intended position has been reached are they lowered vertically onto the sea bed, with the vessel usually then being additionally raised 10 to 20 meters vertically once they have hit the sea bed, so that it is anchored securely to the sea floor by its own weight. This yields a stable working platform on which the at least one crane is used.

The crane as a rule is a large heavy-lift crane which takes on the lifting tasks which occur when erecting the wind power plants of an offshore wind farm. Of course, the wind farm installation vessels may also be used offshore for other lifting tasks.

It is already known to arrange corresponding heavy-lift cranes rotatably on base columns provided specifically for them which are constructed on the large deck surface of the wind farm installation vessel. This method of construction of course has the disadvantage that, in addition to the jack-up legs which have to be provided on the deck surface, an additional superstructure for the heavy-lift crane is also present which occupies stowage surface on the deck surface.

In order to be able to use the space available here even better, it has for example already become known from U.S. Pat. No. 5,580,189 or 4,417,664 to place the crane not on a base column to be provided specifically for this, but to arrange it rotatably about one of the jack-up legs. It is already known from U.S. Pat. No. 4,417,664 A in this case to provide not only one crane on the wind farm installation vessel, but a plurality of cranes.

The cranes used on the wind farm installation vessels as a rule have fairly long jibs in order to be able to construct the high wind power plants. Because they are arranged in the region of one of the jack-up legs, in particular because of the supporting feet which are present, not all points on deck, in particular not in the vicinity of the crane, can be approached with the crane hook.

The object of the present invention is therefore to improve the possibility of deploying the crane.

According to the invention, this object is achieved starting from a generic crane corresponding to the preamble of Claim 1 by a combination of the features of Claim 1.

Accordingly, a crane as a component of a wind farm installation vessel is provided, since it consists of a vessel body and a plurality of jack-up legs arranged in vertically movable manner thereon, wherein the crane is arranged rotatably about one of the jack-up legs. According to the invention, the crane is rotatably mounted on an eccentric platform which itself is arranged rotatably about the jack-up leg.

Due to the provision of the eccentric platform, in principle any crane whatsoever in addition to the turning of the crane about its own axis of rotation can be installed and turned in relation to a second axis of rotation which coincides with the axis of the jack-up leg about which it is rotatably arranged. Due to the provision of the eccentric platform, advantageously because of its own outreach a smaller crane size can be offered.

Due to the movement kinematics of the two pivot points, virtually all points on deck, including the vicinity of the crane, can be approached with the hook.

It is possible to go around obstacles such as for example the jack-up legs without colliding owing to intelligent combinations of slewing angles. The crane itself can be turned to a fixed working position in a simple manner by the crane driver. Because of the eccentric arrangement of the crane, it can also be turned for collision-free loading and unloading with an external crane from the danger zone or loading zone.

Furthermore, due to two suitable eccentric slewing angles a short and a long jib configuration can be allowed for on a relatively small vessel.

Particularly advantageous configuration of the invention will become apparent from the dependent claims following on from the main claim.

In this case, the eccentric platform may have on one side a cutout through which the jack-up leg is passed. The crane can then be received rotatably on the opposite side of the eccentric platform.

According to a further preferred configuration of the invention, the eccentric platform may be rotatable about the jack-up leg by way of a slewing gear mounted on the vessel side, wherein the slewing gear too has a preferably central cutout through which the jack-up leg is passed.

According to a further configuration of the invention, the crane may be rotatably received by way of a slewing gear at the freely projecting end of the eccentric platform.

The jack-up legs can advantageously be extended and retracted by way of drive units arranged on the vessel body, in order thus to anchor the wind farm installation vessel on the sea bed and to raise it accordingly.

Advantageously, the slewing gear for receiving the eccentric platform is arranged on one of the drive units, optionally by way of an adapter.

The crane itself may have a turntable which is connected to the slewing gear, wherein a jib and at least one guy support frame are articulated directly or indirectly on the turntable.

It is particularly advantageous if the jack-up legs and/or the crane jib are formed as a lattice mast.

Finally, a stowage frame for receiving the stowed free jib end is provided in the transport position on the vessel.

Advantageously, it is possible to allow for a regulating means for dual-crane slewing angle control for efficient loading of vessels.

Advantageously, due to the eccentric axis of rotation coinciding with the longitudinal axis of a jack-up leg of the vessel, it is possible to save on the structure for an additional base column on deck, including the associated installation space on deck on the vessel: as a result, more stowage space can be made available on the deck of the vessel body.

Even if as a rule one heavy-lift crane per wind farm installation vessel is provided, in the context of the invention a plurality of cranes can be provided on a wind farm installation vessel. In such case, if need be a corresponding crane may be arranged rotatably about each of the jack-up legs.

Further features, details and advantages of the invention will be discussed with reference to an example of embodiment illustrated in the drawings. Therein:

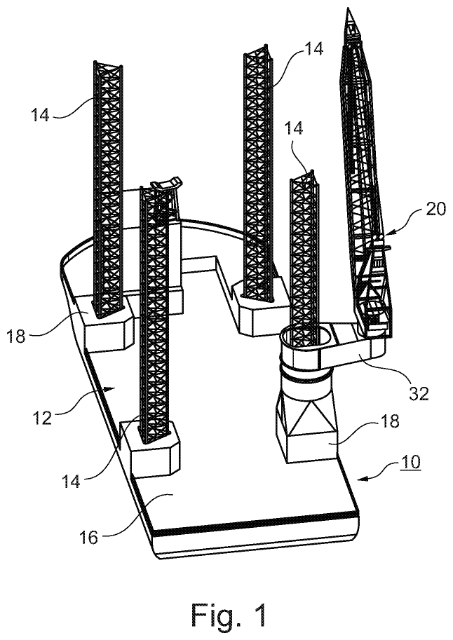

FIG. 1: is a perspective view of a wind farm installation vessel illustrated in simplified manner with a crane according to the invention according to one example of embodiment of the invention,

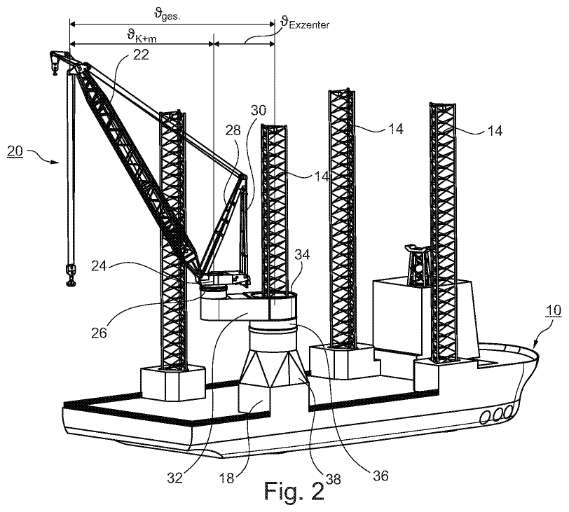

FIG. 2: is a different perspective view of the wind farm installation vessel of FIG. 1, in which the slewing radii of the crane are clearly shown,

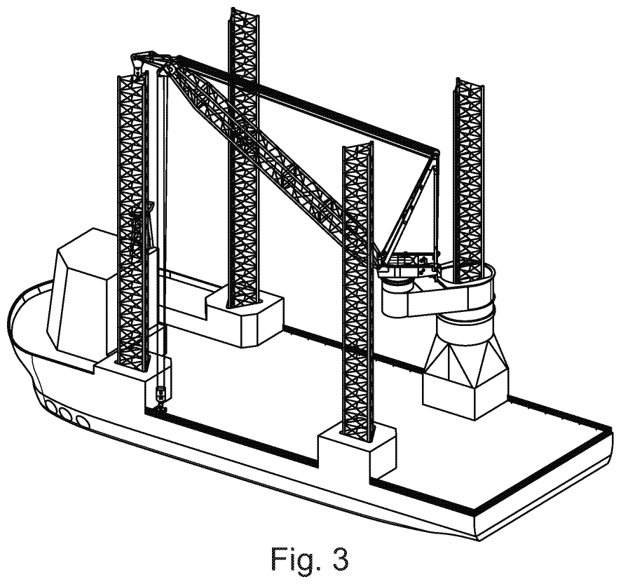

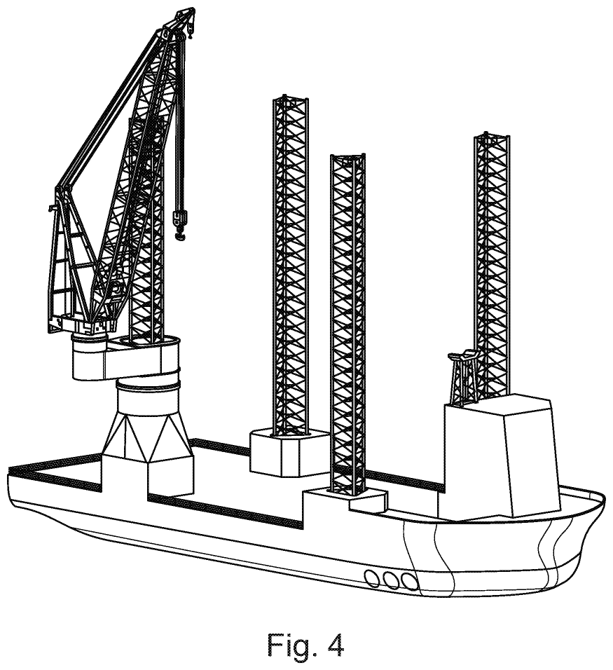

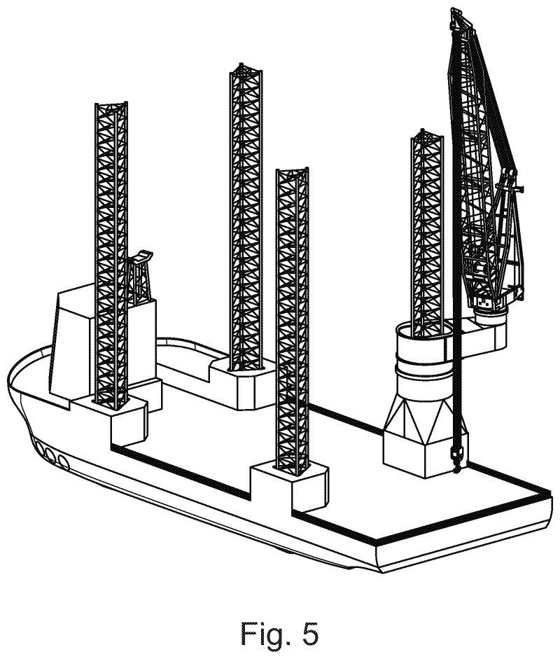

FIGS. 3, 4 and 5: are further illustrations of the wind farm installation vessel of FIG. 1 with different positions of the crane, and

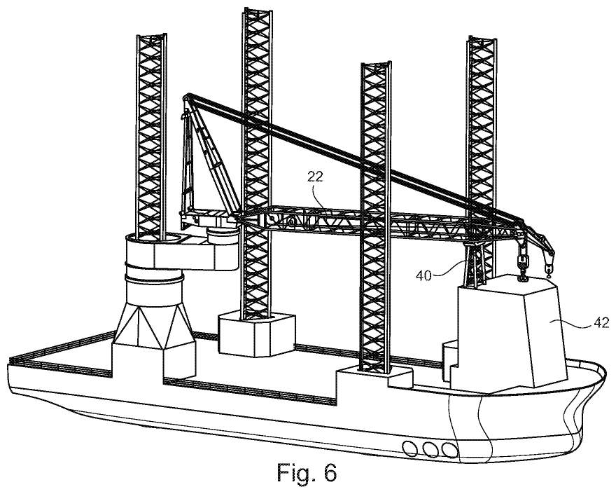

FIG. 6: is an illustration of the wind farm installation vessel of FIG. 1, in which the crane is stowed in a transport position.

FIG. 1 shows a simplified representation of a wind farm installation vessel 10. Such wind farm installation vessels are also referred to as installation ships or, according to the English term, jack-up vessels. In conventional manner, the wind farm installation vessel has jack-up legs 14 arranged in each case laterally in the front and rear region of the vessel body 12. These jack-up legs 14 in the representation of FIG. 1 are illustrated in the travelling position of the wind farm installation vessel. This means that these jack-up legs 14, which in themselves are arranged vertically movably, are arranged in a position projecting upwards over the deck 16. In this position, the wind farm installation vessel 10 typically travels at a speed of up to 15 knots or more, by means of the ship's propulsion units, which are not illustrated in greater detail here.

On reaching the desired position in which the structure, for example a wind turbine, is to be erected offshore, the wind farm installation vessel is anchored to the sea bed by the jack-up legs 14 being moved vertically by drives 18, not illustrated in greater detail here, vertically downwards beneath the vessel body until they hit the sea bed. The jack-up legs 14 in this case, after hitting the sea bed, are used as supports in order to raise the entire vessel body 12 approximately 10-20 meters above the sea surface. In this working position, usually the lift crane 20 provided is then used.

As can be seen in particular from FIG. 2, the lift crane 20 is a conventional maritime heavy-lift crane, which can bear up to approximately 3000 t. The crane has a long jib 22, which is pivotably articulated on a turntable 24. The turntable 24 in turn is mounted on a slewing gear 26. The jib 22 in the example of embodiment illustrated here has a guy support frame 28, 30. In the present example of embodiment, an individual jib 22 is shown as a lattice jib. However, multi-part lattice jibs may also be used here, as illustrated for example in U.S. Pat. No. 5,580,189.

The entire crane 20 is mounted on an eccentric platform 32, as shown in FIG. 2. This eccentric platform has on one side a large cutout 34 through which the jack-up leg is passed. On the opposite, freely projecting, side, the eccentric 32 bears the slewing gear 26 for the crane 20. The eccentric 32 is rotatably mounted by way of a slewing gear 36, which likewise has a central cutout through which the jack-up leg is passed. In this case, the lifting mechanism 36 is constructed by way of an adapter 38 on the drive unit 18 of the jack-up leg 14.

Owing to the method of construction previously described, the crane 20 can first of all be turned about its own axis of rotation by means of the slewing gear 26. Additionally, it can be turned parallel to this own axis of rotation about a second axis of rotation, namely the axis of rotation of the eccentric 32, which coincides with the axis of symmetry of the jack-up leg 14. Thus the radius r_{Kran}, as marked in FIG. 2, is yielded for the slewing radius of the crane itself. The total slewing radius r_{ges} is then yielded by superposition of the slewing radius of the crane r_{Kran} and the slewing radius of the eccentric r_{Exzenter}.

Different positions of the crane which are produced by superposition of the slewing radii r_{Exzenter} and r_{Kran} are illustrated in FIGS. 1-6. As can be recognized using this exemplified positioning, here even when the jack-up legs 14 are extended, as are shown in the illustrations present here, virtually all the regions in the vicinity of the vessel body can be reached with the crane hook.

The position of the crane according to FIG. 1, in which the crane 20 is moved across the eccentric platform 32 into an outer position next to the hull, is particularly advantageous. Here, the wind farm installation vessel can be loaded and unloaded by means of an external crane without colliding.

In FIG. 6, the crane is illustrated in a typical transport position, in which the jib 22 lies on a stowage frame 40. The stowage frame 40 in the example of embodiment present here is constructed on a vessel superstructure 42, which for example represents the bridge of the wind farm installation vessel 10.

1. A crane as a component of a wind farm installation vessel which consists of a vessel body and a plurality of jack-up legs arranged in vertically movable manner thereon, wherein the crane is arranged rotatably about one of the jack-up legs,
wherein
the crane is rotatably mounted on an eccentric platform which itself is arranged rotatably about a jack-up leg.

2. The crane according to claim 1, wherein the eccentric platform comprises on one side a cutout through which the jack-up leg is passed, and in that it rotatably receives the crane on an opposite side.

3. The crane according to claim 1, wherein the eccentric platform is rotatable about the jack-up leg by way of a slewing gear mounted on a vessel side, wherein the slewing gear too comprises a preferably central cutout through which the jack-up leg is passed.

4. The crane according to claim 1, wherein the crane is rotatably received by way of a slewing gear at a freely projecting end of the eccentric platform.

5. The crane according to claim 3, wherein the jack-up legs can be extended and retracted by way of drive units arranged on the vessel body.

6. The crane according to claim 5, wherein the slewing gear for receiving the eccentric platform is arranged on one of the drive units, optionally by way of an adapter.

7. The crane according to claim 3, wherein the crane has a turntable which is connected to the slewing gear, wherein a jib and at least one guy support frame are articulated directly or indirectly on the turntable.

8. The crane according to claim 1, wherein the jack-up legs and/or a crane jib are formed as a lattice mast.

9. The crane according to claim 1, wherein a stowage frame for receiving a stowed free jib end in a transport position is provided on the vessel.

10. A wind farm installation vessel having a crane according to one of claim 1.
